(19) United States
(12) Patent Application Publication
(10) Pub. No.: US 2015/0088688 A1
(43) Pub. Date: Mar. 26, 2015

(54) E-COMMERCE SYSTEM AND ITS AUTHENTICATION METHOD

(71) Applicant: Rakuten, Inc., Shinagawa-ku, Tokyo (JP)

(72) Inventors: Tomoaki Sakadume, Shinagawa-ku (JP); Ryu Watanabe, Shinagawa-ku (JP); Takashi Shirota, Shinagawa-ku (JP)

(73) Assignee: Rakuten, Inc, Shinagawa-ku, Tokyo (JP)

(21) Appl. No.: 14/391,973

(22) PCT Filed: Sep. 21, 2012
(86) PCT No.: PCT/JP2012/074301

§ 371 Date: Oct. 10, 2014

(51) Int. Cl. G06Q 30/06; G06Q 20/12; H04L 29/06

(52) U.S. Cl. CPC G06Q 30/0633; H04L 63/08; G06Q 20/12
USPC 705/26.8

(57) ABSTRACT

Provided is an e-commerce system capable of preventing fraudulent orders by third parties and performing smooth operation of item orders. An authentication method of the e-commerce system includes a receiving step of receiving a procedure request for performing an ordering procedure from a user device, and a first screen sending step of sending an authentication screen or a review screen to the user device in accordance with communication control information that is stored in the user device and included in the procedure request. The authentication method also includes a second screen sending step of obtaining the authentication information that is input in the authentication screen, causing the user device to store the communication control information in accordance with the obtained authentication information, and sending the review screen to the user device. Further, the authentication method includes a receiving step of receiving a request for changing the delivery address sent from the user device in response to an operation on the review screen, and a re-authenticating step of re-authenticating the user in a case where the request for changing the delivery address is received and the first screen sending means has sent the review screen to the user device.

### TECHNICAL FIELD

The present invention relates to an e-commerce system and its authentication method, in particular, to controlling transition of screens, which include a user authentication screen, for ordering items.

### BACKGROUND ART

Recently, it is known to use a so-called e-commerce system in which a user orders an item at a website established on the Internet, and the item is delivered to an address specified by the user. Such an e-commerce system typically requires a user to apply for a membership registration in advance so as to prevent unauthorized use. In addition, the system typically requires the user to input an ID and a password until the order is finalized by displaying a user authentication screen on a user device. The patent document below discloses performing authentication of a user with use of a device number specifically assigned to a client computer to eliminate a trouble of personal authentication.

### CITATION LIST

### Patent Literature

Patent Literature 1: JP2004-302910A

### SUMMARY OF INVENTION

### Technical Problem

However, if an ID and a password are always required at the time of ordering an item, it may make it difficult to smoothly order the item and may reduce usability for a user. On the other hand, if an ID and a password are not required, a concern over fraudulent orders by third parties may arise.

One or more embodiments of the present invention have been conceived in view of the above, and an object thereof is to provide an e-commerce system and its authentication method for preventing fraudulent orders by third parties and enabling smooth operation of item orders.

### Solution to Problem

In order to solve the above described problems, an e-commerce system according to an embodiment of the present invention includes procedure request receiving means for receiving a request for performing an ordering procedure of an item from a user device, first screen sending means for sending, to the user device, an authentication screen for obtaining authentication information of a user of the user device or a review screen for displaying a delivery address of the item, based on communication control information that is stored in the user device and included in the procedure request, second screen sending means for obtaining the authentication information that is input in the authentication screen, causing the user device to store the communication control information in accordance with the obtained authentication information, and sending the review screen to the user device, delivery address change request receiving means for receiving a request for changing the delivery address sent from the user device in response to an operation on the review screen, and re-authentication means for performing re-authentication of the user in a case where the request for changing the delivery address is received and the first screen sending means has sent the review screen to the user device.

The delivery address stored in advance may be displayed on the review screen before the delivery address is changed in response to the request for changing the delivery address.

The communication control information may include qualification information indicating that the authentication using the authentication information has been already performed and screen control information indicating whether or not to restrict sending the authentication screen.

At this time, the authentication screen may display an entry field indicating whether or not to restrict sending the authentication screen.

The first screen sending means may send the authentication screen or the delivery address review screen to the user device depending on the screen control information.

At this time, in a case where the screen control information indicates that sending the authentication screen is restricted, the first screen sending means may send to the user device the delivery address review screen or a payment method specifying screen for specifying the payment method, depending on whether or not a payment is performed using card information stored in advance. The first screen sending means may send the authentication screen to the user device in a case where the screen control information indicates that sending the authentication screen is not restricted.

An authentication method of an e-commerce system includes a receiving step for receiving a request for performing an ordering procedure of an item from a user device, a first screen sending step of sending, to the user device, an authentication screen for obtaining authentication information of a user of the user device or a review screen for displaying a delivery address of the item, based on communication control information that is stored in the user device and included in the procedure request, and a second screen sending step of obtaining the authentication information that is input in the authentication screen, causing the user device to store the communication control information in accordance with the obtained authentication information, and sending the review screen to the user device. The authentication method of an e-commerce system further includes a receiving step of receiving a request for changing the delivery address sent from the user device in response to an operation on the review screen, and a re-authenticating step of re-authenticating the user in a case where the request for changing the delivery address is received and the review screen has been sent to the user device in the first screen sending step.

### BRIEF DESCRIPTION OF DRAWINGS

FIG. 1A diagram illustrating an overall configuration of an e-commerce network according to an embodiment of the present invention.

FIG. 2A diagram illustrating an example of a purchase item specifying screen.

FIG. 3A diagram illustrating an example of a shopping list screen.

FIG. 4A diagram illustrating screen transitions relating to ordering an item in an e-commerce system according to the embodiment of the present invention.

FIG. 5A diagram illustrating an example of a login screen.

FIG. 6A diagram illustrating an example of a payment/delivery method input screen.

FIG. 7A diagram illustrating an example of a review screen.

FIG. 8A diagram illustrating an example of password input (re-authentication) screen.

FIG. 9A diagram illustrating an example of an order completion screen.

FIG. 10A diagram illustrating a configuration of communication control information.

FIG. 11A flow chart illustrating processing of a request for purchasing procedure.

FIG. 12A flow chart illustrating login processing.

FIG. 13A flow chart illustrating input processing of payment/delivery method.

FIG. 14A flow chart illustrating reviewing processing.

### DESCRIPTION OF EMBODIMENTS

An embodiment of the present invention will be described below in detail with reference to the accompanying drawings.

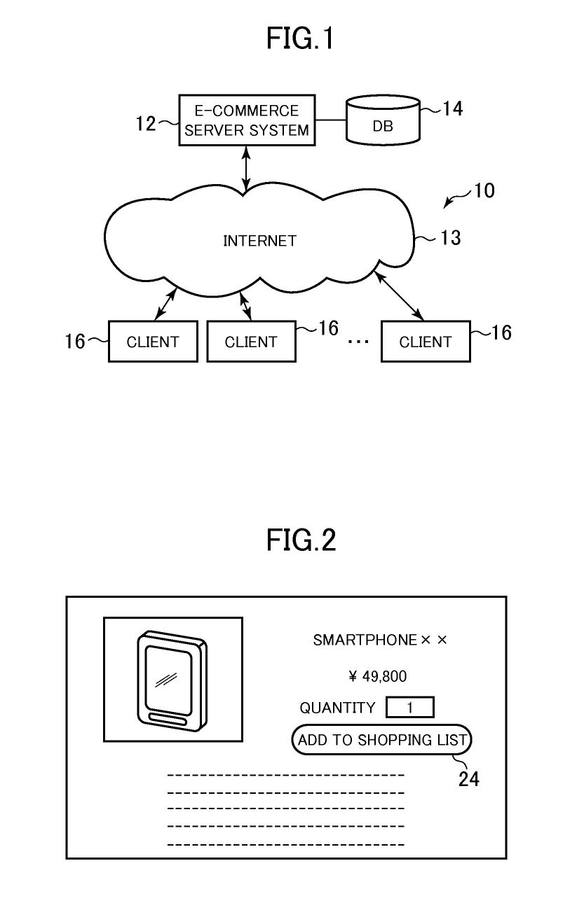

FIG. 1 is an overall schematic diagram of an e-commerce network according to an embodiment of the present invention. The e-commerce network 10 shown in FIG. 1 includes an e-commerce server system (e-commerce system) 12 connected to the Internet 13, and a plurality of clients (user devices) 16, which are similarly connected to the Internet 13 and used by the respective users of the e-commerce service. A client 16 is composed of a computer, such as a personal computer, a mobile phone, a smartphone, and a consumer game machine. The e-commerce server system 12 is composed of one or more server computers. The e-commerce server system 12 is connected to a database 14, which is composed of a storage device such as hard disk. In this embodiment, the e-commerce network 10 is mainly composed of the Internet 13, although other data communication networks may of course be available.

The e-commerce server system. 12 provides e-commerce services in response to a request from a client 16 of a user who has applied for a membership registration. Specifically, the e-commerce server system 12 has functions for allowing the user to specify an item to purchase, receiving a request relating to payment and delivery, and processing the payment and delivery in response to the request.

The database 14 stores information on the users of the e-commerce service. Here, the database 14 stores IDs, passwords, names, addresses, telephone numbers of registered users, names and addresses relating to default delivery addresses, and credit card information (e.g., name of credit card company, credit card number, expiration date, and security code). In this regard, a user optionally stores credit card information in the database 14. The database 14 also stores item information on each item, such as an item ID, name, price, and shop. Further, the database 14 stores information on whether or not each shop accepts credit card payment. In addition, the database 14 temporarily stores order information including a list of items (shopping list) that a user wants to purchase in association with the user's ID.

FIG. 2 is a diagram illustrating an example of a purchase item specifying screen displayed on a display device of a client 16. The purchase item specifying screen is displayed on the client 16 based on data (e.g., HTML data) sent from the e-commerce server system 12 in response to a request from the client 16. The user operates the client 16 to previously display an item list screen (not shown) that is sent from the e-commerce server system 12, and selects one of the items displayed in the list. In this way, the user requests the e-commerce server system 12 to send data of the purchase item specifying screen of the specified item. With this, the purchase item specifying screen shown in FIG. 2 is displayed on the client 16. The user selects a button 24 of “add to shopping list” shown in FIG. 2 using a pointing device such as a mouse, to thereby send an item ID of the item that the user wishes to purchase to the e-commerce server system 12. The shopping list is also referred to as a shopping basket or a shopping cart. In the e-commerce server system 12, the item ID is associated with the user's ID and stored in the database 14. With such procedures, the user can store item IDs of one or more items that the user wishes to purchase in the database 14 in association with the user's ID.

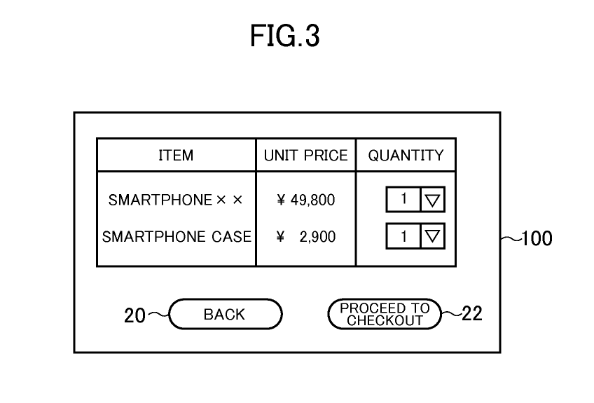

A request for displaying the shopping list is sent from the client 16 to the e-commerce server system 12, so that the list of these items is displayed on the client 16. FIG. 3 is a diagram illustrating an example of a shopping list screen displayed on the display device of the client 16. As shown in FIG. 3, the shopping list screen 100 displays lists of names and prices of the items that the user wishes to purchase and are specified by the item IDs stored in the database 14 in association with the user's ID. Pull-down menus for specifying the number of respective items are also displayed so that the number of purchase items is increased or decreased. The shopping list screen 100 includes a “Back” button 20 and “Proceed to Checkout” button 22. When the “Back” button 20 is selected, the item list screen (not shown) is once again displayed on the client 16. In this way, the user can add another item to the shopping list. When the “Proceed to Checkout” button 22 is selected, a request for processing an order of the item in the shopping list is sent to the e-commerce server system 12.

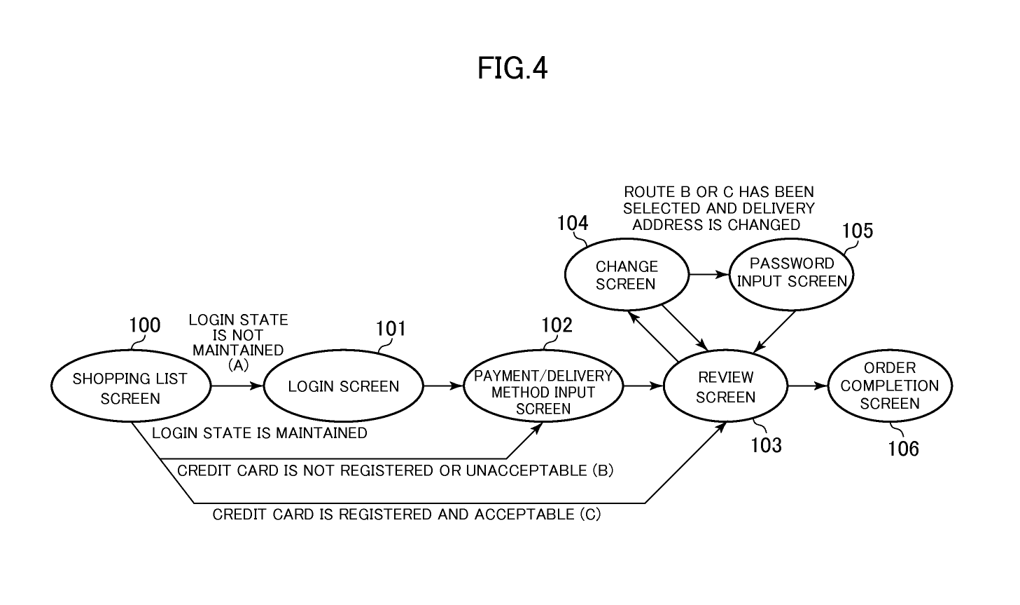

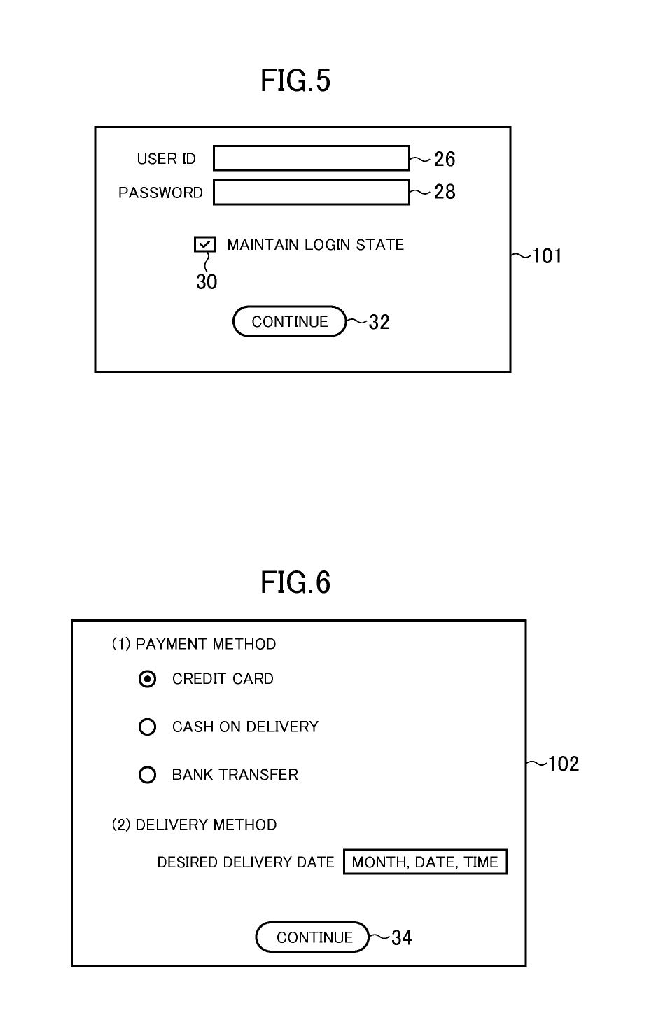

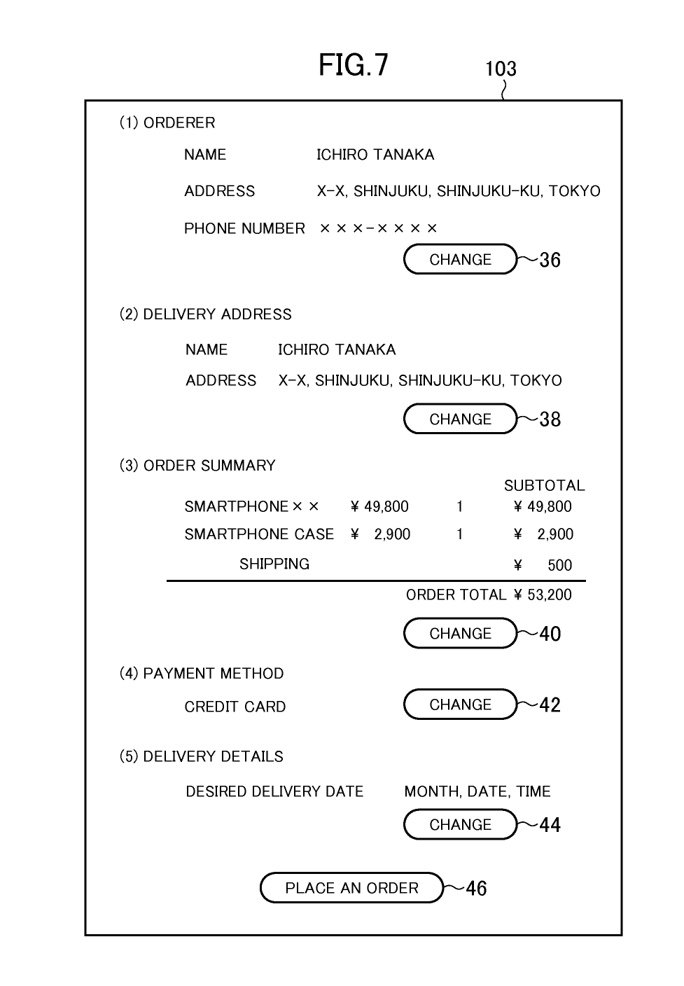

FIG. 4 is a diagram illustrating screen transitions relating to ordering an item in the e-commerce system according to the embodiment of the present invention. As shown in FIG. 4, when the “Proceed to Checkout” button 22 is selected on the shopping list screen 100 (FIG. 3), one of a login screen 101 shown in FIG. 5, a payment/delivery method input screen shown in FIG. 6, and a review screen 103 shown in FIG. 7 is displayed on the client 16. These screens are also displayed on the client 16 based on the data (e.g., HTML data) sent from the e-commerce server system 12. Specifically, if communication control information 49, which is sent from the client 16 to the e-commerce server system 12 when the “Proceed to Checkout” button 22 is selected, includes a login maintaining flag 52 (see FIG. 10) indicating that login is not maintained, the screen transitions to the login screen 101 (route A). If the communication control information 49 includes a login maintaining flag 52 indicating that login state is maintained and true qualification information 50, the screen transitions to the payment/delivery method input screen 102 or the review screen 103 according to whether or not a credit card can be used. That is, if the database 14 stores the credit card information in association with the user's ID, and also stores information indicating that the shop selling an item to purchase accepts credit card payment, the screen transitions to the review screen 103 (route C), and if not, the screen transitions to the payment/delivery method input screen 102 (route B).

As shown in FIG. 5, the login screen 101 includes an entry field 26 of the user ID, an entry field 28 of the password, and a checkbox 30. Here, the checkbox 30 is used to indicate that login state is maintained. If the checkbox is checked, the login maintaining flag 52 stores information that login state is maintained, and displaying the login screen 101 on the client 16 is prevented. When the user selects “Continue” button 32 on the login screen 101, information on content in the entry fields 26 and 28 and the checkbox 30 is sent to the e-commerce server system 12.

When true authentication information (ID and password) is input in the login screen 101, the communication control information 49 includes true qualification information 50, and the screen transitions to the payment/delivery method input screen 102. When the payment and delivery methods are input in the payment/delivery method input screen 102 shown in FIG. 6, and the button 34 is selected, the screen transitions to the review screen 103 shown in FIG. 7. The review screen 103 displays order information on an orderer, a delivery address, shopping content, delivery and payment methods. The orderer, delivery address, and shopping content are included in information stored in the database 14 in advance. In a case where the payment/delivery method input screen 102 has been displayed, the payment and delivery methods are determined based on information input in the payment/delivery method input screen 102. In a case where the payment/delivery method input screen 102 has not been displayed, that is, if the shopping list screen 100 directly transitions to the review screen 103, the payment method is a credit card payment, and the delivery method is a default method (e.g., no desired delivery date).

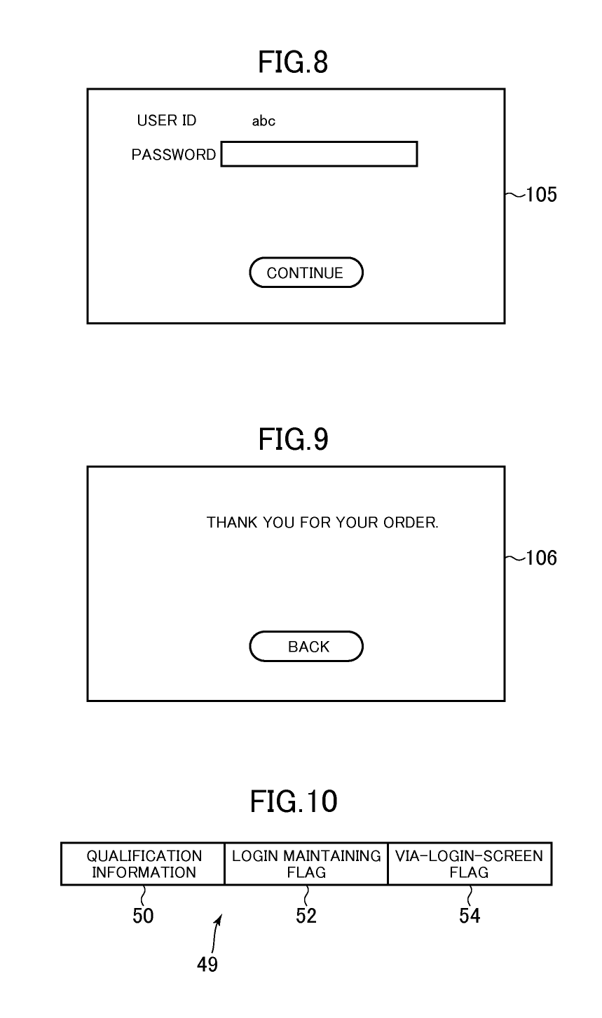

If the user wishes to change the order information on the review screen 103, the user presses any of the buttons 36, 38, 40, 42, and 44 in order to display the change screen 104 for changing information corresponding to the pressed button. When the change in the order information is input in the change screen 104, the screen returns to the review screen 103. In this case, the changed order information is displayed on the review screen 103. In this regard, in a case where the button 38 is selected to change the delivery address on the change screen 104, a password input screen 105 shown in FIG. 8 is displayed according to the route of the screen transition (in a case of route B or route C). When the true password is input in the password entry field on the password input screen 105 and the “Continue” button is selected, the screen returns to the review screen 103. In this case, the order information including the changed delivery address is displayed on the review screen 103. When the button 46 is selected to place an order in the review screen 103, the payment and delivery arrangement is processed according to the order information on the review screen 103, and the screen transitions to an order completion screen 106 shown in FIG. 9. The change screen 104, the password input screen 105, and the order completion screen 106 are also displayed on the client 16 based on data (e.g., HTML data) sent from the e-commerce server system 12. When the credit card payment is processed, the credit card information stored in the database 14 is used for processing the payment.

In the following, information processing of the e-commerce server system 12 will be described in detail. FIG. 10 is a diagram illustrating the configuration of communication control information 49 that the e-commerce server system 12 stores in the client 16. The client 16 is configured to include the communication control information 49 in a request whenever sending a request to the e-commerce server system 12. Such system can be implemented easily by using technique called Cookie, for example. As shown in FIG. 10, the communication control information 49 includes qualification information 50, a login maintaining flag 52, and a via-login-screen flag 54. The qualification information 50 is stored when the true ID and password are input in the login screen 101, and certifies a proper qualification to access the e-commerce server system 12. The qualification information 50 may include information on expiration dates. The login maintaining flag 52 stores information indicating that login state is maintained in a case where the checkbox 30 is checked on the login screen 101, and stores information indicating that login state is not maintained in a case where the checkbox 30 is not checked. In a case where the shopping list screen 100 transitions to the login screen 101 (route A), the via-login-screen flag 54 stores information indicating that the login screen 101 has been displayed. In a case where the shopping list screen 100 directly transitions to the payment/delivery method input screen 102 (route B) or the shopping list screen 100 directly transitions to the review screen 103 (route C), the via-login-screen flag 54 stores information indicating that the login screen 101 has not been displayed.

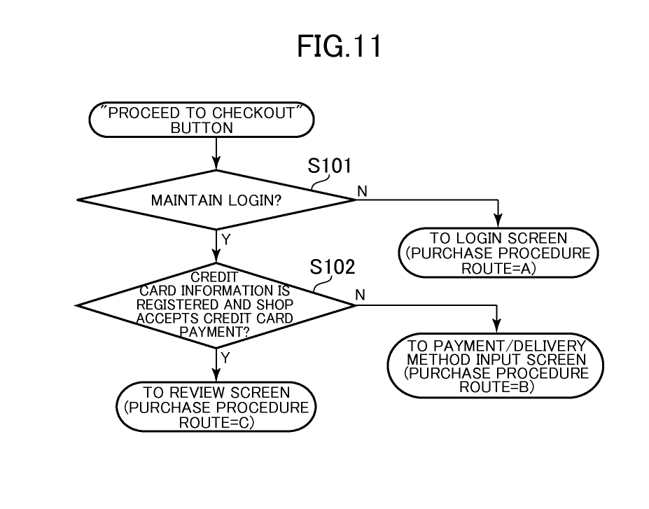

FIG. 11 is a flow chart illustrating the processing of a request for purchasing process performed in the e-commerce server system 12. The processing shown in FIG. 11 is performed in the e-commerce server system 12 when the “Proceed to Checkout” button 22 is selected on the shopping list screen 100. The processing begins with referring to the communication control information 49 sent from the client 16 in order to determine whether or not the login maintaining flag 52 indicates that login state is maintained (S101). If the flag does not indicate that the login state is maintained, the screen transitions to the login screen 101. At this time, the client 16 stores information indicating that the login screen 101 has been displayed in the via-login-screen flag 54 of the communication control information 49.

If the flag indicates that the login state is maintained, it is determined whether or not a condition, in which the credit card information of the user is stored in the database 14 and the shop that sells the item that the user wants to purchase accepts a credit card payment, is satisfied (S102). If the condition is satisfied, data of the review screen 103 is sent to the client 16. At this time, the client 16 stores information indicating that the login screen 101 has not been displayed in the via-login-screen flag 54 of the communication control information 49.

If it is determined that the condition is not satisfied in S102, data of the payment/delivery method input screen 102 is sent to the client 16. At this time, the client 16 stores information indicating that the login screen 101 has not been displayed in the via-login-screen flag 54 of the communication control information 49.

In S102, it is desirable to check whether or not the qualification information 50 included in the communication control information 49 is true, and, if it is false, to exceptionally send data of the login screen 101 to the client 16.

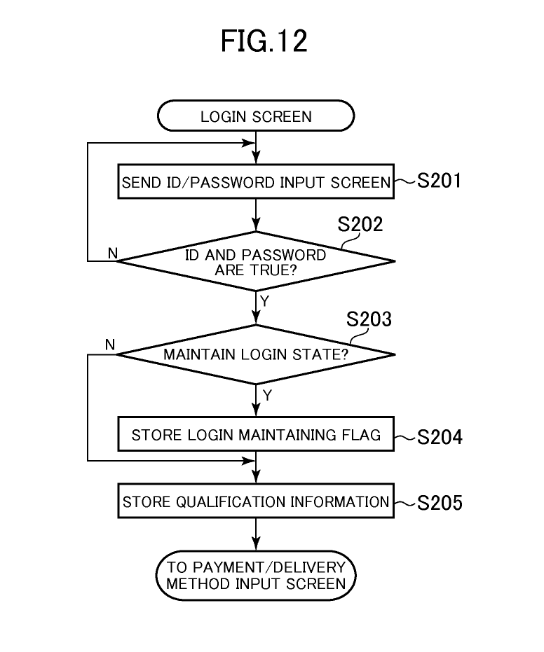

FIG. 12 is a flow chart illustrating login processing of the e-commerce server system 12. The processing shown in FIG. 12 is executed if NO in S101 of FIG. 12, and the e-commerce server system 12 sends data of the login screen 101 to the client 16 (S201). At this time, as described above, the client 16 stores information indicating that the login screen 101 has been displayed in the via-login-screen flag 54 of the communication control information 49. Subsequently, the e-commerce server system 12 receives data of the entry fields 26 and 28 and the checkbox 30 on the login screen 101 from the client 16, and determines whether or not the ID and the password are true (S202). If the ID and the password are false, the processing returns to S201. If the ID and the password are true, it is determined whether or not the checkbox 30 is checked (S203). If it is checked, the screen transitions to the payment/delivery method input screen 102. At this time, the e-commerce server system 12 sets the login maintaining flag 52 of the communication control information 49 stored in the client 16 to maintain the login state (S204), and causes the client 16 to store the true qualification information 50. If it is determined that the checkbox 30 is not checked in S203, the screen also transitions to the payment/delivery method input screen 102. At this time, the e-commerce server system 12 does not set the login maintaining flag 52 of the communication control information 49 stored in the client 16 to maintain the login state, and causes the client 16 to store the true qualification information 50.

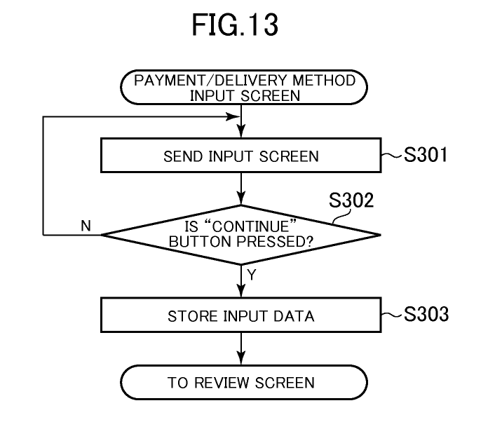

FIG. 13 is a flow chart illustrating processing of payment/delivery methods performed in the e-commerce server system 12. The processing shown in FIG. 13 is executed after the processing shown in FIG. 12, or if NO in S102 of FIG. 11. First, the e-commerce server system 12 sends data of the payment/delivery method input screen 102 to the client 16. In a case where the processing shown in FIG. 13 is executed in response to NO determined in S102 of FIG. 11, at the time the data of the payment/delivery method input screen 102 is sent to the client 16, the client 16 stores information indicating that the login screen 101 has not been displayed in the via-login-screen flag 54 of the communication control information 49.

Subsequently, it is determined whether or not the “Continue” button 34 is pressed (S302). If the button is pressed, the e-commerce server system 12 receives from the client 16 the data indicating content that is input in the payment/delivery method input screen 102, and stores the received data in the database 14 in association with the user's ID as apart of the order information. The screen then transitions to the review screen 103.

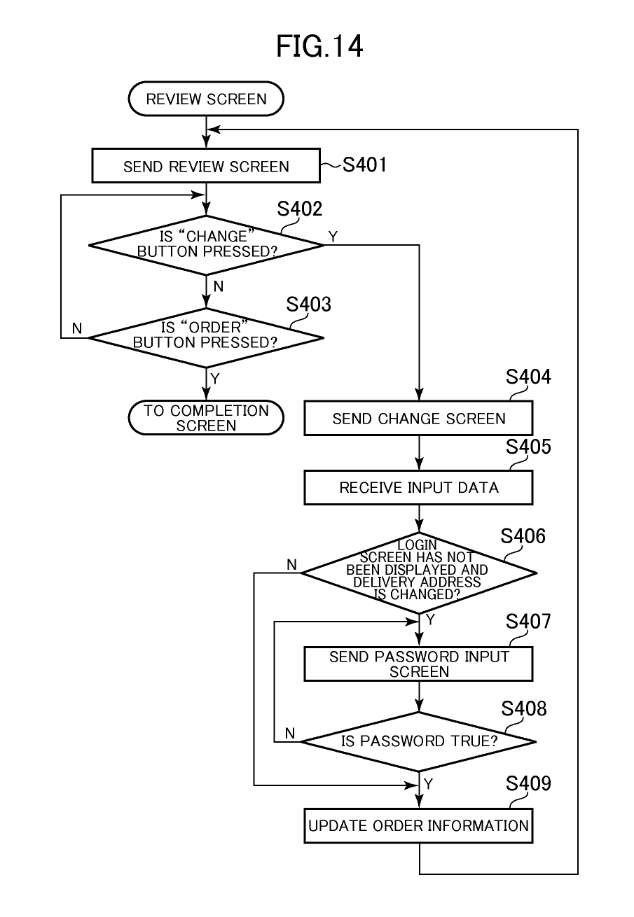

FIG. 14 is a flow chart illustrating reviewing processing performed in the e-commerce server system 12. The processing shown in FIG. 14 is executed after the processing shown in FIG. 13, or if YES in S102 of FIG. 11. First, the e-commerce server system 12 sends data of the review screen 103 to the client 16. In a case where the processing shown in FIG. 14 is executed in response to YES determined in S102 of FIG. 11, the client 16 stores information indicating that the login screen 101 has not been displayed in the via-login-screen flag 54 of the communication control information 49, as described above.

Subsequently, it is determined whether or not the buttons 36, 38, 40, 42, and 44 are selected on the review screen 103 for changing order information (S402). When any of the buttons 36, 38, 40, 42, and 44 is selected, data of the change screen according to the selected button is sent to the client 16 (S404). The e-commerce server system 12 then receives from the client 16 the data input in the screen (S405), updates the order information stored in the database 14 based on the received data, and returns to S401.

Here, if the data received from the client 16 is to change the delivery address of the item and the via-login-screen flag 54 included in the communication control information 49 indicates that the login screen 101 has not been displayed (S406), data of the password input screen 105 is sent to the client 16 (S407). The e-commerce server system 12 then receives the password entered in the screen, and determines whether or not the password is true (S408). If the password is not true, the e-commerce server system 12 sends the data of the password input screen 105 to the client 16 again (S407). If the password is true, the e-commerce server system 12 updates the delivery address of the order information stored in the database 14 based on the data received from the client 16 (S409), and returns to S401.

If it is determined in S402 that none of the buttons 36, 38, 40, 42, and 44 is selected, then it is determined whether or not the button 46 for placing the order is selected (S403). If the button 46 is not selected, the processing returns to S402. If the button 46 is selected, the e-commerce server system 12 sends the data of the order completion screen 106 to the client 16. At this time, if the login maintaining flag 52 included in the communication control information 49 indicates that the login state is not maintained, the qualification information 50 stored in the client 54 is deleted.

According to the embodiment described above, once the true ID and password are entered into the login screen 101 and the checkbox 30 is checked, the screen can transition from the shopping list screen 100 to the payment/delivery method input screen 102 (route B) or the review screen 103 (route C) without the login screen 101 being displayed. Specifically, if the credit card information is registered in the database 14 in advance, the screen transitions from the shopping list screen 100 to the review screen 103 (route C) with respect to the purchase from the shop where the credit card payment is available. If the button 46 is selected here, the order is placed. That is, the user can place the order by pressing the buttons twice in a state where the shopping list screen 100 is displayed on the client 16, and thus can enjoy shopping very quickly. When the delivery address is changed on the review screen 103, it is required to enter a password into the password input screen 105 according to the screen transitions up to the review screen 103. That is, in a case where the screen directly transitions from the shopping list screen 100 to the review screen without the login screen 101 being displayed (route C) and the screen transitions from the shopping list screen 100 to the payment/delivery method input screen 102 without the login screen 101 being displayed (route B), the password needs to be entered. In this way, in a case where the user tries to send the item to an address that is different from the delivery address registered in the database 14 in advance, the identity of the user can be verified. In other words, in a case where the item is ordered without entering the ID and password, the user can only select the delivery address registered in the database 14 in advance, and needs to enter the password in order to change the delivery address. In this way, smooth ordering of items is available while preventing fraudulent orders by third parties.

In a case where the screen directly transitions from the shopping list screen 100 to the payment/delivery method input screen 102 (route B), the credit card payment using the credit card information registered in the database 14 in advance is not available, and thus the user has no option but to select from cash on delivery and bank transfer, which less likely relate to the fraudulent orders, as a payment option. As such, in a case where the screen directly transitions from the shopping list screen 100 to the payment/delivery method input screen 102 (route B), a password may not be required even when the delivery address is changed.

1. An e-commerce system comprising:
a procedure request receiving unit configured to receive a procedure request for performing an ordering procedure of an item from a user device;
a first screen sending unit configured to send, to the user device, an authentication screen for obtaining authentication information of a user of the user device in a case where the user of the user device is not authenticated based on communication control information that is stored in the user device and included in the procedure request, or a review screen for displaying a delivery address of the item in a case where the user is authenticated based on the communication control information;
a second screen sending unit configured to obtain the authentication information that is input in the authentication screen, causing the user device to store the communication control information in accordance with the obtained authentication information, and send the review screen to the user device;
a delivery address change request receiving unit configured to receive a request for changing the delivery address sent from the user device in response to an operation on the review screen; and
a re-authentication unit configured to perform re-authentication of the user in a case where the request for changing the delivery address is received and the first screen sending unit has sent the review screen to the user device, and not to perform re-authentication of the user but to perform authentication of the user based on the communication control information in a case where the request for changing the delivery address is received and the first screen sending unit has sent the authentication screen to the user device.

2. The e-commerce system according to claim 1,
wherein the delivery address stored in advance is displayed on the review screen before the delivery address is changed in response to the request for changing the delivery address.

3. The e-commerce system according to claim 1,
wherein the communication control information includes qualification information indicating that the authentication using the authentication information has already been performed and screen control information indicating whether or not to restrict sending the authentication screen.

4. The e-commerce system according to claim 3,
wherein the authentication screen displays an entry field indicating whether or not to restrict sending the authentication screen.

5. The e-commerce system according to claim 3,
wherein the first screen sending unit sends the authentication screen or the review screen to the user device depending on the screen control information.

6. The e-commerce system according to claim 5,
wherein, in a case where the screen control information indicates that sending the authentication screen is restricted, the first screen sending unit sends to the user device the review screen or a payment method specifying screen for specifying the payment method, depending on whether or not a payment is performed using card information stored in advance, and sends the authentication screen to the user device in a case where the screen control information indicates that sending the authentication screen is not restricted.

7. An authentication method of an e-commerce system comprising:
a procedure request receiving step of receiving, by a procedure request receiving unit, a procedure request for performing an ordering procedure of an item from a user device;
a first screen sending step of sending, by a first screen sending unit, to the user device, an authentication screen for obtaining authentication information of a user of the user device in a case where the user of the user device is not authenticated based on communication control information that is stored in the user device and included in the procedure request, or a review screen for displaying a delivery address of the item in a case where the user is authenticated based on the communication control information;
a second screen sending step of obtaining, by a second screen sending unit, the authentication information that is input in the authentication screen, causing the user device to store the communication control information in accordance with the obtained authentication information, and sending the review screen to the user device;
a delivery address change request receiving step of receiving, by a delivery address change request receiving unit, a request for changing the delivery address sent from the user device in response to an operation on the review screen; and
a re-authentication step of performing, by a re-authentication unit, re-authentication of the user in a case where the request for changing the delivery address is received and the first screen sending unit has sent the review screen to the user device, and authentication of the user based on the communication control information without performing re-authentication of the user in a case where the request for changing the delivery address is received and the first screen sending unit has sent the authentication screen to the user device.

8. The e-commerce system according to claim 7,
wherein the delivery address stored in advance is displayed on the review screen before the delivery address is changed in response to the request for changing the delivery address.

9. The e-commerce system according to claim 7,
wherein the communication control information includes qualification information indicating that the authentication using the authentication information has been already performed and screen control information indicating whether or not to restrict sending the authentication screen.

10. The e-commerce system according to claim 9,
wherein the authentication screen displays an entry field indicating whether or not to restrict sending the authentication screen.

11. The e-commerce system according to claim 9,
wherein the first screen sending unit sends the authentication screen or the review screen to the user device depending on the screen control information.

12. The e-commerce system according to claim 11,
wherein, in a case where the screen control information indicates that sending the authentication screen is restricted, the first screen sending unit sends to the user device the review screen or a payment method specifying screen for specifying the payment method, depending on whether or not a payment is performed using card information stored in advance, and sends the authentication screen to the user device in a case where the screen control information indicates that sending the authentication screen is not restricted.

13. A non-transitory computer readable information storage medium that stores a program for causing a computer to function as:
a procedure request receiving unit configured to receive a request for performing an ordering procedure of an item from a user device;
a first screen sending unit configured to send, to the user device, an authentication screen for obtaining authentication information of a user of the user device in a case where the user of the user device is not authenticated based on communication control information that is stored in the user device and included in the procedure request, or a review screen for displaying a delivery address of the item in a case where the user is authenticated based on the communication control information;
a second screen sending unit configured to obtain the authentication information that is input in the authentication screen, causing the user device to store the communication control information in accordance with the obtained authentication information, and send the review screen to the user device;
a delivery address change request receiving unit configured to receive a request for changing the delivery address sent from the user device in response to an operation on the review screen; and
a re-authentication unit configured to perform re-authentication of the user in a case where the request for changing the delivery address is received and the first screen sending unit has sent the review screen to the user device, and not to perform re-authentication of the user but to perform authentication of the user based on the communication control information in a case where the request for changing the delivery address is received and the first screen sending unit has sent the authentication screen to the user device.

14. The non-transitory computer-readable information storage medium according to claim 13,
wherein the delivery address stored in advance is displayed on the review screen before the delivery address is changed in response to the request for changing the delivery address.

15. The non-transitory computer-readable information storage medium according to claim 13,
wherein the communication control information includes qualification information indicating that the authentication using the authentication information has been already performed and screen control information indicating whether or not to restrict sending the authentication screen.

16. The non-transitory computer-readable information storage medium according to claim 15,
wherein the authentication screen displays an entry field indicating whether or not to restrict sending the authentication screen.

17. The non-transitory computer-readable information storage medium according to claim 15,
wherein the first screen sending unit sends the authentication screen or the review screen to the user device depending on the screen control information.

18. The non-transitory computer-readable information storage medium according to claim 17,
wherein, in a case where the screen control information indicates that sending the authentication screen is restricted, the first screen sending unit sends to the user device the review screen or a payment method specifying screen for specifying the payment method, depending on whether or not a payment is performed using card information stored in advance, and sends the authentication screen to the user device in a case where the screen control information indicates that sending the authentication screen is not restricted.
